(19) United States
(12) Patent Application Publication
(10) Pub. No.: US 2004/0076217 A1
(43) Pub. Date: Apr. 22, 2004

(54) Wave-collecting device of non-contact type thermometer

(76) Inventor: Kevin Lin, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/267,637

(22) Filed: Oct. 10, 2002

(51) Int. Cl. G01J 5/00

(52) U.S. Cl. 374/121

(57) ABSTRACT

A wave-collecting device of a non-contact type thermometer comprises a main body. An ellipsoid groove is disposed in the main body. The groove can be composed of at least two inclined planes. An opening is disposed at the bottom of the ellipsoid groove and located above a focus thereof. An ellipsoid reflecting mirror is disposed on the surface of the ellipsoid groove. A sensor is disposed below the opening at the bottom of the ellipsoid groove. The detection head of the sensor is located at the focus. In addition to being directly incident onto the sensor, infrared rays emitted by a target at the other focus of the ellipsoid groove can be reflected by the ellipsoid reflecting mirror once to be focused onto the sensor. Therefore, stable and reliable infrared energy reception can be accomplished. Moreover, the advantage of low cost can be achieved.

### FIELD OF THE INVENTION

The present invention relates to a non-contact type thermometer and, more particularly, to a wave-collecting device of a non-contact type thermometer having better infrared reception characteristic.

### BACKGROUND OF THE INVENTION

Recently, along with continual development of the industry and highly scientific industries, the temperatures of many manufacturing processes must be strictly controlled, wherein the industrial thermometer plays an important role. Because infrared thermometers can measure the temperature without contact with a target, they are widely applied to measure the temperature of hot places and the surface of machinery, and the temperature of rotary, uneven, or places hard to contact. Moreover, the user can stand off the hot source during measurement.

A wave-collecting device in an infrared thermometer is a main factor affecting the reliability of measurement. As shown in FIG. 1, in the disclosure of U.S. Pat. No. 4,005,605 about a conventional infrared wave-collecting device, a sensor 12 capable of detecting infrared radiation energy is disposed in a gun body 10. The detection head of the sensor 12 faces inwards toward a reflecting mirror 14. When infrared rays enter, more directly incident light will be blocked by the sensor 12. Only a small part of slantingly incident light will be reflected by the reflecting mirror 14 to the sensor 12. Therefore, the sensor 12 has no directly incident infrared energy reception and thus is difficult to accurately measure the temperature. Moreover, in this disclosure, it is necessary for the relative optical positions to be very accurate. If there is any deviation, the measure error will be much larger.

As shown in FIG. 2, in the disclosure of U.S. Pat. No. 4,634,294, a sensor 12 is disposed between a first reflecting mirror 16 and a second reflecting mirror 18. The two reflecting mirrors 16 and 18 are used to shrink visual angle and reduce incidence of external indiscriminate light. Therefore, infrared rays are reflected by the first reflecting mirror 16 to the second reflecting mirror 18, and are then reflected by the second reflecting mirror 18 to the sensor 12 for measurement. In this disclosure, in order to let infrared rays be successfully reflected to the sensor 12, the curvatures and relative installation positions of the two reflecting mirrors 16 and 18 must be precisely calculated and positioned. Moreover, because infrared rays are at least reflected twice to reach the sensor 12, there is the problem of energy attenuation. The above reasons make this disclosure have difficulty in embodiment, a high price, and a low reliability.

As described above, in a conventional infrared thermometer, a reflecting mirror 14 is used to reflect infrared rays to a sensor 12, or two reflecting mirrors 16 and 18 are used to reflect infrared rays twice to the sensor 12. The same drawback of the above two disclosures is that the sensor 12 can hardly receive directly incident infrared energy, resulting in unstable energy reception. As shown in FIG. 3, in the disclosure of U.S. Pat. No. 5,860,740, a filter 20 is disposed in front of a sensor 1. Infrared rays within the visual angle (θ) of the wave-collecting device thereof pass through the filter 20 and then are directly reflected to the sensor 12. However, the filter 20 only has the effect of screening foreign matter and has no focusing function. Moreover, because the filter 20 is planar, it relatively enlarges the visual angle. That is, infrared lights emitted by objects not to be measured at angles larger than 0 can also pass through the filter 20 and then reach the sensor 12 after several times of reflection, hence letting the sensor 12 easily measure the temperature of objects not to be measured. In the disclosure of U.S. Pat. No. 5,626,424, a convex lens is disposed in front of a sensor to focus directly incident infrared rays onto the sensor, hence shrinking the visual angle of the wave-collecting device thereof. However, because the convex lens is formed by polishing a silicon chip into a spherical lens, the cost of the optical system is very expensive and thus cannot be popularized.

Additionally, in the disclosure of U.S. Pat. No. 4,636,091, in order to enhance the accuracy of measurement, a measurement head thereof needs to be tightly stuck with an object to be measured. However, this will let the heat of the object be quickly absorbed by the measurement head to cause an abrupt change of the temperature of the measurement head, hence affecting the stability of the temperature of the sensor and resulting in inaccuracy of the measurement. Moreover, this disclosure has no design of a focusing device so that the measurement angle is larger and the visual angle cannot be shrunk.

Accordingly, based on the design rule of simplified structure and lower cost matched with the requirement of high infrared reception, the present invention proposes a wave-collecting device of an infrared thermometer having an ellipsoid reflecting mirror to effectively resolve the problems in the prior art.

### SUMMARY OF THE INVENTION

The primary object of the present invention is to provide a wave-collecting device of a non-contact type thermometer, wherein an ellipsoid reflecting mirror is provided to let a sensor in the thermometer have the highest infrared reception under the premises of the simplest structure design and lower cost.

Another object of the present invention is to shrink the visual angle of a wave-collecting device and effectively reduce the interference of external indiscriminate light, thereby enhancing the accuracy of measurement without adding any focusing lens and reducing the size of the thermometer's gun body.

According to the present invention, a wave-collecting device of a non-contact type thermometer comprises a main body. An ellipsoid groove is disposed in the main body. An opening is disposed at the bottom of the ellipsoid groove and located above a focus thereof. The ellipsoid groove is composed of at least two inclined planes. An ellipsoid reflecting mirror is disposed on the surface of the ellipsoid groove. A sensor is disposed below the opening at the bottom of the ellipsoid groove. The detection head of the sensor is located at the focus.

The various objects and advantages of the present invention will be more readily understood from the following detailed description when read in conjunction with the appended drawing, in which:

### BRIEF DESCRIPTION OF THE DRAWINGS

FIG. 1 is a diagram of a conventional infrared wave-collecting device;

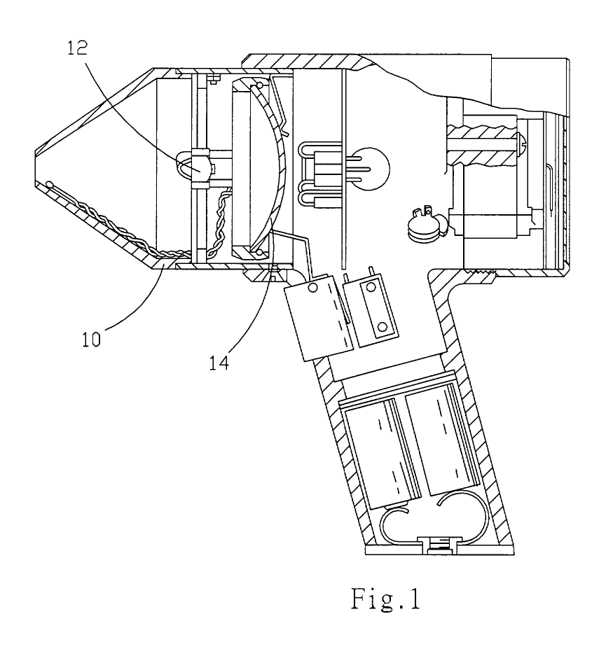

FIG. 2 is a diagram of another conventional infrared wave-collecting device;

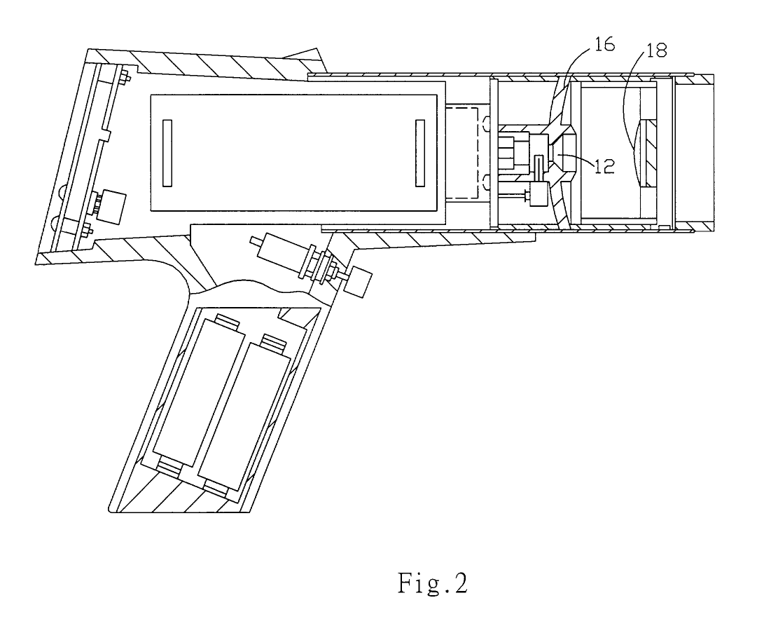

FIG. 3 is a diagram of yet another conventional infrared wave-collecting device;

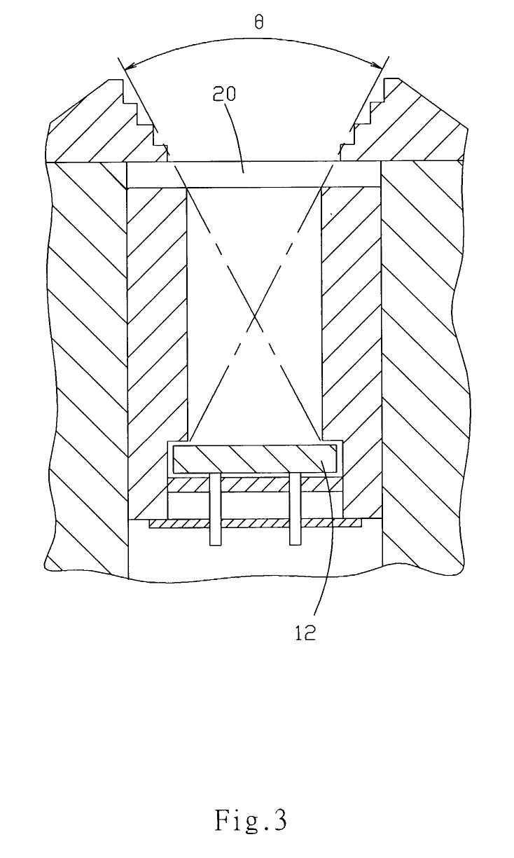

FIG. 4 is a structure diagram of the present invention;

FIG. 5 is a diagram of another embodiment of the present invention;

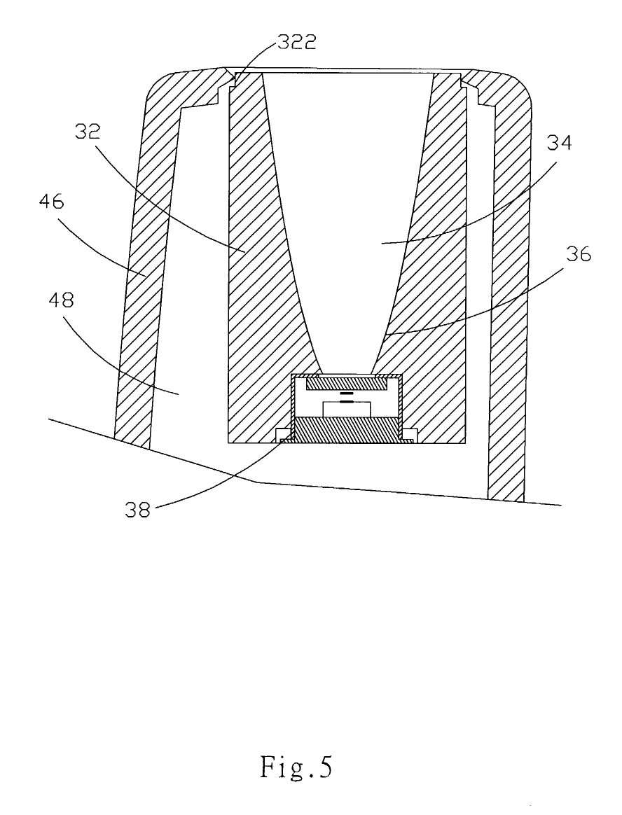

FIG. 6 is a diagram showing an ellipsoid reflecting path of the present invention;

FIG. 7 is a diagram of the present invention used for wave collection;

FIG. 8 is a diagram showing the relationship between the visual angle and absorbed infrared energy of the present invention;

FIG. 9 is a diagram of yet another embodiment of the present invention; and

FIG. 10 is a diagram of still yet another embodiment of the present invention.

### DETAILED DESCRIPTION OF THE PREFERRED EMBODIMENTS

The present invention designs a waveguide pipe of an infrared thermometer as an ellipsoid surface, and lets a sensor be located at a focus of the ellipsoid surface. When a target is located near the other focus of the ellipsoid surface, the infrared thermometer can have highest infrared reception.

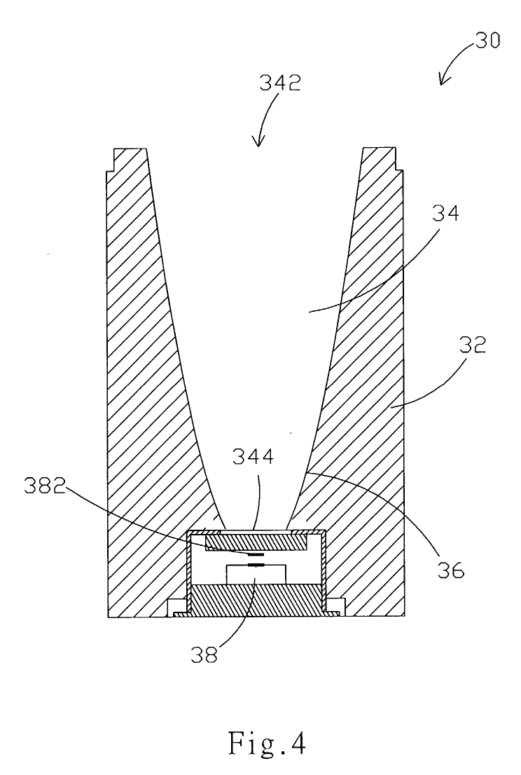

As shown in FIG. 4, a wave-collecting device 30 of a non-contact type thermometer comprises a main body 32 made of thermal absorptive material (usually being zinc alloy, aluminum alloy or copper alloy) to absorb thermal energy radiated by external objects not to be measured. The main body 32 has an ellipsoid groove 34 with a notch 342. An opening 344 is disposed at the bottom of the ellipsoid groove 34 and located at the focus thereof. The surface of the ellipsoid groove 34 is coated with a layer of metal having a low infrared emissivity and anti-oxidizing function (like gold or nickel) to form an ellipsoid reflecting mirror 36. In order to let the ellipsoid reflecting mirror 36 meet the requirement of total reflection, the ellipsoid groove 34 should have no defects like pores or bumps when being die-cast. Moreover, circular and small ceramic grains are used to polish the ellipsoid groove 34 before electroplating so as to let the surface of the ellipsoid groove 34 be smooth. A sensor 38 is disposed below the opening 344 at the bottom of the ellipsoid groove 34. A detection head 382 of the sensor 38 is located at the focus of the ellipsoid groove 34. Moreover, the sensor 38 has good thermal contact with the main body 32 so that the main body 32 can absorb heat energy outside the sensor 38 to reduce thermal interference.

In order to let the sensor 38 be not influenced by external temperature change as far as possible, a housing 46 is annularly disposed at the periphery of the main body 32. There is only line contact between a top edge 322 of the main body 32 and the housing 46. An air gap 48 is formed at the position where the main body 32 does not contact the housing 46 to reduce the probability of thermal interference source being conducted from the housing 46 to the sensor 38.

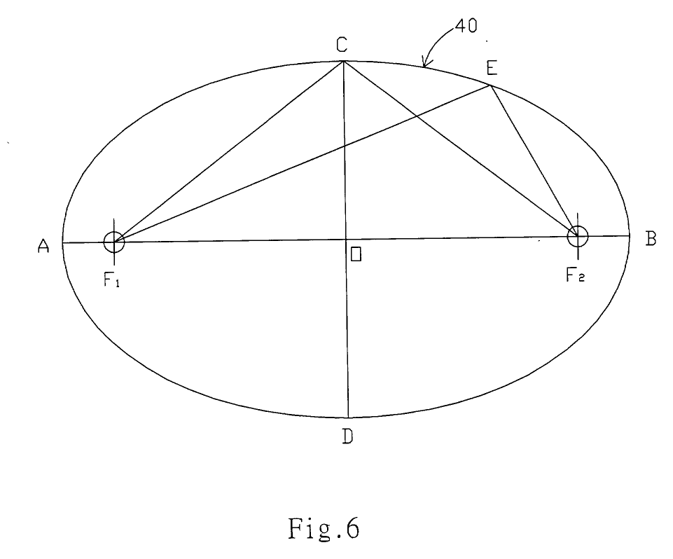

The present invention uses the ellipsoid reflecting mirror 36 to collect waves. As shown in FIG. 6, an ellipse 40 has two focuses F₁ and F₂ respectively located at two ends of an inner major axis A-B of the ellipse 40. From the properties of ellipse, we have the following equations:

\overline{AO}=\overline{BO}=a, \overline{CO}=\overline{DO}=b, \overline{F₁O}=\overline{F₂O}=c,

\overline{AF₁}=\overline{AO}−\overline{F₁O}=a−c

\overline{CF₁}+\overline{CF₂}=\overline{EF₁}+\overline{EF₂}=\overline{AB}=2a

c²=a²−b²

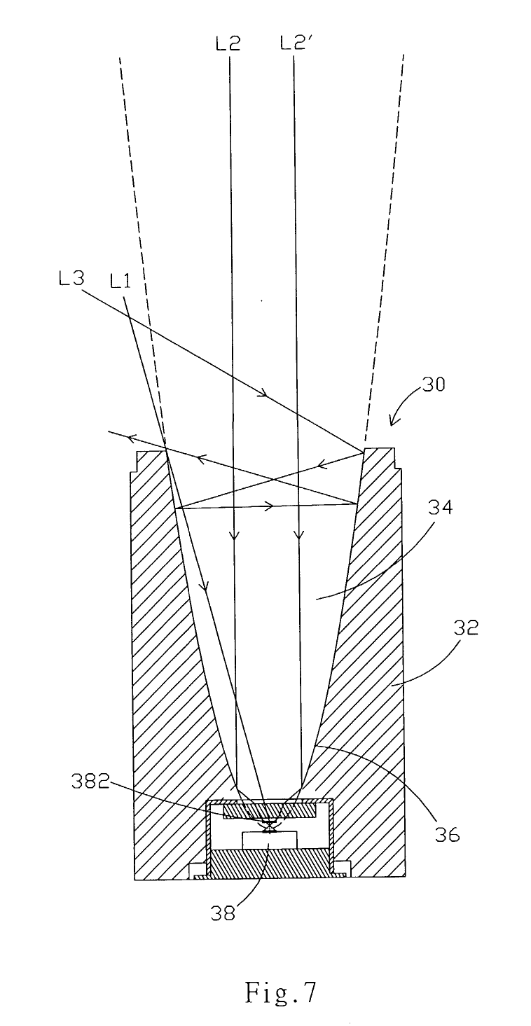

Light wave emitted from any focus (F₁ or F₂) of the ellipse is reflected by the curve of the ellipse 40 and then reaches the other focus (F₂ or F₁), hence accomplishing the focusing function through one time of reflection. Utilizing this principle, the ellipsoid reflecting mirror 36 is disposed in the wave-collecting device 30 of a non-contact type thermometer, and the detection head 382 of the sensor 38 is located at the focus F₁. As shown in FIG. 7, when a target to be measured is located near the focus F₂, in addition to having light L1 directly incident onto the sensor 38, the infrared thermal energy radiated by the target has also indirectly incident lights L2 and L2′, which will be reflected by the ellipsoid reflecting mirror 36 and then focused onto the detection head 382 of the sensor 38 located at the focus F₁. Therefore, the wave-collecting device 30 of the non-contact type thermometer can accomplish infrared focusing function without any lens. On the other hand, when the two focuses F₁ and F₂ of the ellipse are approximately infinitely far apart (i.e., the ratio of the major axis A-B to the minor axis C-D of the ellipse is very large), the infrared thermal energy L2 and L2′ directly radiated by a target in front of the wave-collecting device 30 of the non-contact type thermometer will almost be reflected by the ellipsoid reflecting mirror 36 once and then focused onto the detection head 382 of the sensor 38.

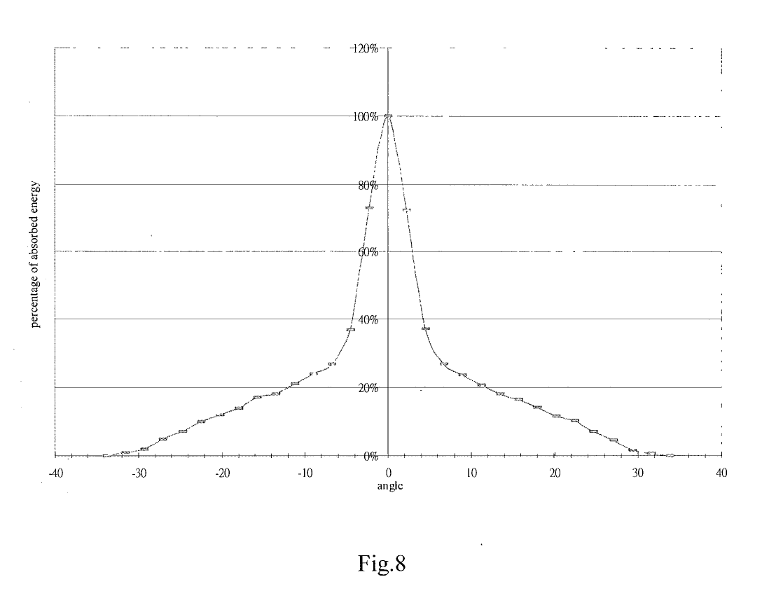

The ellipsoid reflecting mirror 36 also shrinks the visual angle of the wave-collecting device 30 of the non-contact type thermometer. As shown in FIG. 8, the present invention has larger absorbed infrared energies when the visual angle is about within 10 degrees, and the absorbed infrared energy decreases abruptly when the visual angle exceeds 10 degrees. Therefore, as shown in FIG. 7, external indiscriminate light L3 emitted by objects outside the visual angle will reflected out of the ellipsoid groove 34 by the ellipsoid reflecting mirror 36. The present invention can thus reduce the inference of external indiscriminate light to lower the measurement error.

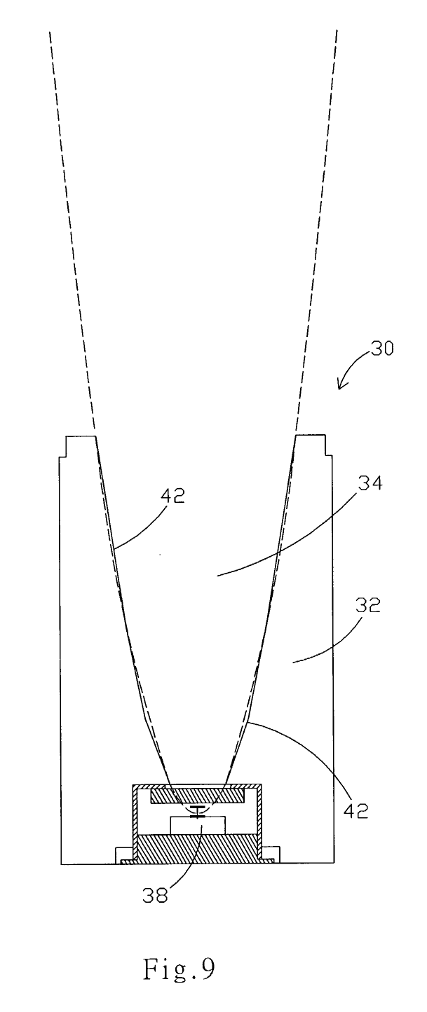

Additionally, as shown in FIG. 9, the ellipsoid groove 34 in the wave-collecting device 30 of the non-contact type thermometer can be composed of two or three inclined planes 42 to form a shape similar to an ellipsoid. The surface of the ellipsoid groove 34 is coated to form the ellipsoid reflecting mirror 36, which has the focusing function described above and can effectively receive infrared rays emitted by a target.

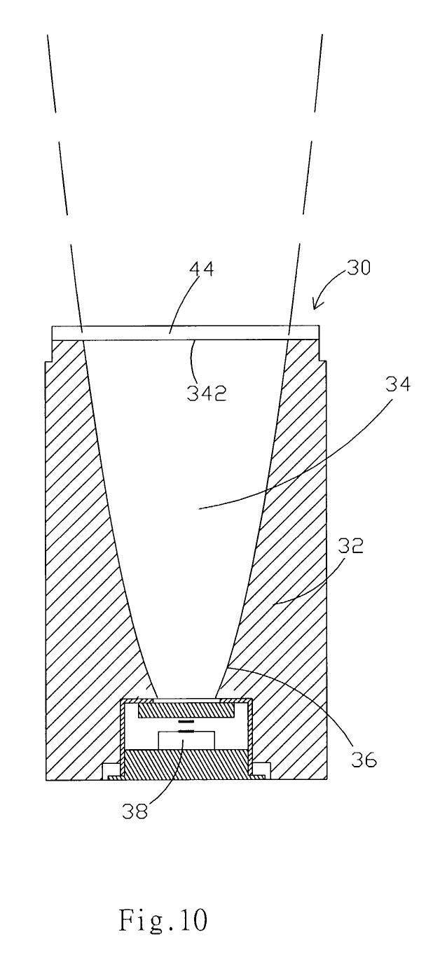

As shown in FIG. 10, a filter 44 is disposed at a notch 342 of the ellipsoid groove 34 to close the ellipsoid groove 34, hence preventing external contaminants from dropping into the ellipsoid groove 34 and thus avoiding contamination of the sensor 38. The filter 44 is made of material of low infrared emissivity like polypropylene (PP), polyethylene (PE), high density PE (HDPE), or a silicon single crystal chip to prevent the filter 44 from emitting too much infrared rays itself to affect measurement. If the strength factor of the PP, HDPE, or PE is taken into account, the HDPE is a better material. Its thickness is preferred to be 0.04˜0.06 mm. If the silicon single crystal chip is adopted, its thickness is preferred to be 0.3˜0.5 mm.

The present invention utilizes an ellipsoid reflecting mirror formed on the surface of an ellipsoid groove by coating to form a waveguide region of a wave-collecting device so that a detection head of a sensor at the focus of the ellipsoid reflecting mirror can have highest infrared reception. The present invention can shrink the visual angle and reduce the inference of external indiscriminate light to lower the measurement error and to further decrease the size of the gun body of the thermometer without any expensive focusing lens. Moreover, because infrared rays reflected by the ellipsoid reflecting mirror to the sensor is only reflected once, their energy hardly attenuates. The present invention thus has the advantage of accurate and stable infrared reception. Furthermore, because there is no focusing lens designed in front of the sensor, the sensor is less heated by infrared rays emitted by the lens to measure an erroneous temperature. Therefore, the present invention can accomplish the effect of accurately receive infrared rays of a target and have the advantage of low cost without any complicated optical system.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A wave-collecting device of a non-contact type thermometer, comprising:
a main body having an ellipsoid groove therein, an opening being disposed at a bottom of said ellipsoid groove and located above a focus thereof;
an ellipsoid reflecting mirror disposed on a surface of said ellipsoid groove; and
a sensor disposed below said opening at the bottom of said ellipsoid groove, a detection head of said sensor being located at said focus.

2. The wave-collecting device of a non-contact type thermometer as claimed in claim 1, wherein a housing is further disposed around said main body, said housing forms a line contact with said main body, and an air gap is formed at the area of said main body not in contact with said housing.

3. The wave-collecting device of a non-contact type thermometer as claimed in claim 1, wherein said main body is made of thermal absorptive material, and said sensor has good thermal contact with said main body.

4. The wave-collecting device of a non-contact type thermometer as claimed in claim 3, wherein said thermal absorptive material is selected among zinc alloy, aluminum alloy, and copper alloy.

5. The wave-collecting device of a non-contact type thermometer as claimed in claim 1, wherein said ellipsoid reflecting mirror is formed by coating metal having a low infrared emissivity.

6. The wave-collecting device of a non-contact type thermometer as claimed in claim 1, wherein said ellipsoid reflecting mirror is formed by coating gold or nickel.

7. The wave-collecting device of a non-contact type thermometer as claimed in claim 1, wherein a filter is further disposed at a notch of said ellipsoid groove to close said ellipsoid groove.

8. The wave-collecting device of a non-contact type thermometer as claimed in claim 7, wherein said filter is made of material having a low infrared emissivity.

9. The wave-collecting device of a non-contact type thermometer as claimed in claim 7, wherein the material of said filter is selected among polypropylene, polyethylene, high density polyethylene, and silicon single crystal chip.

10. A wave-collecting device of a non-contact type thermometer, comprising:
a main body having an ellipsoid groove composed of at least two inclined planes therein, an opening being disposed at a bottom of said ellipsoid groove and located above a focus thereof;
an ellipsoid reflecting mirror disposed on a surface of said ellipsoid groove; and
a sensor disposed below said opening at the bottom of said ellipsoid groove, a detection head of said sensor being located at said focus.

11. The wave-collecting device of a non-contact type thermometer as claimed in claim 10, wherein a housing is further disposed around said main body, said housing forms a line contact with said main body, and an air gap is formed at the area of said main body not in contact with said housing.

12. The wave-collecting device of a non-contact type thermometer as claimed in claim 10, wherein said main body is made of thermal absorptive material, and said sensor has good thermal contact with said main body.

13. The wave-collecting device of a non-contact type thermometer as claimed in claim 12, wherein said thermal absorptive material is selected among zinc alloy, aluminum alloy, and copper alloy.

14. The wave-collecting device of a non-contact type thermometer as claimed in claim 10, wherein said ellipsoid reflecting mirror is formed by coating metal having a low infrared emissivity.

15. The wave-collecting device of a non-contact type thermometer as claimed in claim 10, wherein said ellipsoid reflecting mirror is formed by coating gold or nickel.

16. The wave-collecting device of a non-contact type thermometer as claimed in claim 10, wherein a filter is further disposed at a notch of said ellipsoid groove to close said ellipsoid groove.

17. The wave-collecting device of a non-contact type thermometer as claimed in claim 16, wherein said filter is made of material having a low infrared emissivity.

18. The wave-collecting device of a non-contact type thermometer as claimed in claim 16, wherein the material of said filter is selected among polypropylene, polyethylene, high density polyethylene, and silicon single crystal chip.
